(19) United States
(12) Patent Application Publication
(10) Pub. No.: US 2007/0035517 A1
(43) Pub. Date: Feb. 15, 2007

(54) COMPUTER MOUSE WITH MICROPHONE AND LOUDSPEAKER

(75) Inventors: Iou-Din Jean Chen, San Jose, CA (US); Han-Hsin Liu, Taipei County (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: FORTEMEDIA, INC., Cupertino, CA (US)

(21) Appl. No.: 11/463,947

(22) Filed: Aug. 11, 2006

Related U.S. Application Data
(60) Provisional application No. 60/708,410, filed on Aug. 15, 2005.
(60) Provisional application No. 60/779,583, filed on Mar. 6, 2006.

(51) Int. Cl. G09G 5/08

(52) U.S. Cl. 345/163

(57) ABSTRACT

A computer mouse includes a body, a microphone module, and a loudspeaker, wherein the microphone module and the loudspeaker are fixed to the body. The microphone module is disposed at the front, a side, or the top of the body. The body includes a speaker chamber with the loudspeaker disposed therein and an acoustic opening provided thereon. The acoustic opening is disposed at the front, a side, or the top of the body.

### BACKGROUND OF THE INVENTION

1. Field of the Invention

The invention relates to a computer mouse with a microphone and a loudspeaker.

2. Description of the Related Art

A computer mouse is mainly used for controlling movement of a cursor on a display. Referring to FIG. 1, a computer mouse 20 includes a sensor 22 and a controller 21. The sensor 22 detects movement of the mouse 20 and generates a signal. The controller 21 processes the signal to obtain a track signal and transmits the track signal to a computer 10 for controlling the movement of the cursor on the display.

In addition to a computer mouse, other computer peripherals include a keyboard, a microphone, a loudspeaker etc., all of which significantly reduce the available space on the desktop.

### BRIEF SUMMARY OF THE INVENTION

The invention integrates a computer mouse with a microphone module and a loudspeaker, thereby increasing the available space on the desktop and improving the work environment.

The computer mouse of the invention includes a body, a microphone module, and a loudspeaker, wherein the microphone module and the loudspeaker are fixed to the body.

The microphone module may be disposed at the front, a side, or the top of the body.

The microphone module may include a main microphone and a reference microphone, wherein the main microphone may be omni-directional or unidirectional. Similarly, the reference microphone 32 may be omni-directional or unidirectional.

The body may include a speaker chamber with the loudspeaker disposed therein and an acoustic opening provided thereon. The acoustic opening may be disposed at the front, a side, or the top of the body.

The computer mouse may be a USB mouse including a voice processor, a sensor, a controller, and a hub. The microphone module receives sound and generates an electrical signal. The voice processor processes the electrical signal to obtain an acoustic signal. Also, the sensor detects movement of the USB mouse and generates a signal. The controller processes the signal to obtain a track signal. The hub arbitrates the track signal and the acoustic signal for output. The voice processor may perform beam-forming, noise suppression, and echo cancellation on the electrical signal to obtain the acoustic signal.

Furthermore, the computer mouse may be a Bluetooth mouse including a voice processor, a sensor, and a controller. The microphone module receives sound and generates an electrical signal. The voice processor processes the electrical signal to obtain an acoustic signal. Also, the sensor detects movement of the Bluetooth mouse and generates a signal. The controller processes the signal and the acoustic signal and generates a Bluetooth signal for output. The voice processor may perform beam-forming, noise suppression, and echo cancellation on the electrical signal to obtain the acoustic signal.

### BRIEF DESCRIPTION OF THE DRAWINGS

The invention can be more fully understood by reading the subsequent detailed description and examples with references made to the accompanying drawings, wherein:

FIG. 1 is a block diagram of a conventional computer mouse;

FIG. 2A is a top view of a computer mouse in accordance with a first embodiment of the invention;

FIG. 2B is a side view of a computer mouse in accordance with a first embodiment of the invention;

FIG. 3A is a top view of a computer mouse in accordance with a second embodiment of the invention;

FIG. 3B is a side view of a computer mouse in accordance with a second embodiment of the invention;

FIG. 3C is a front view of a computer mouse in accordance with a second embodiment of the invention;

FIG. 4 is a block diagram of a USB mouse in accordance with the invention; and

FIG. 5 is a block diagram of a Bluetooth mouse in accordance with the invention.

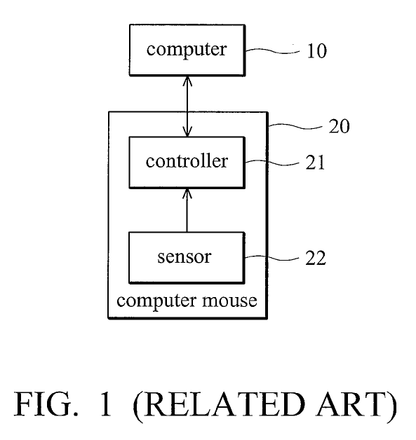

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

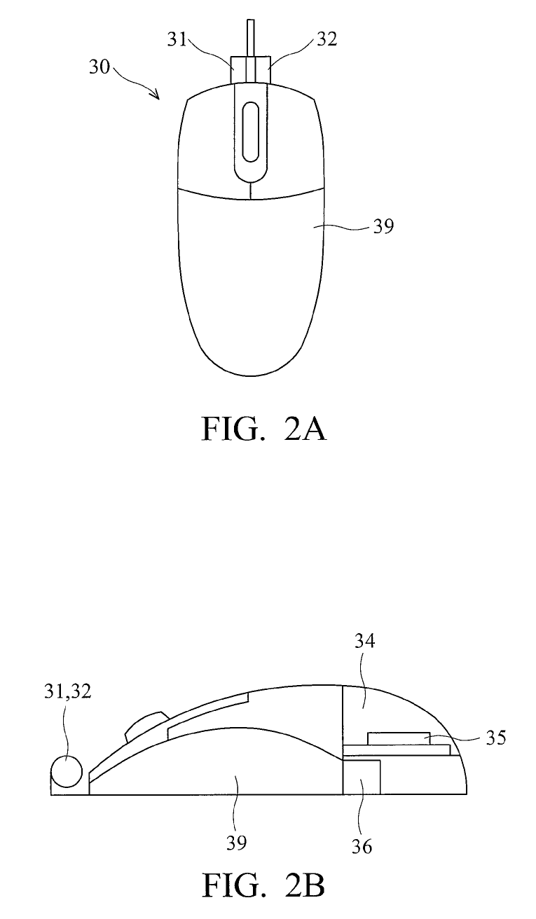

FIGS. 2A and 2B depict a first embodiment of a computer mouse of the invention, wherein the computer mouse 30 comprises a body 39. A microphone module including a main microphone 31 and a reference microphone 32 is fixed to the front of the body 39 for receiving sound. The main microphone 31 may be omni-directional or uni-directional. Similarly, the reference microphone 32 may be omni-directional or uni-directional.

The body 39 includes a speaker chamber 34 with a loudspeaker 35 disposed therein and an acoustic opening 36 provided thereon. Thus, sound from the loudspeaker 35 is transmitted through the acoustic opening 36 to the outside. In this embodiment, the acoustic opening 36 is provided at a side of the body 39.

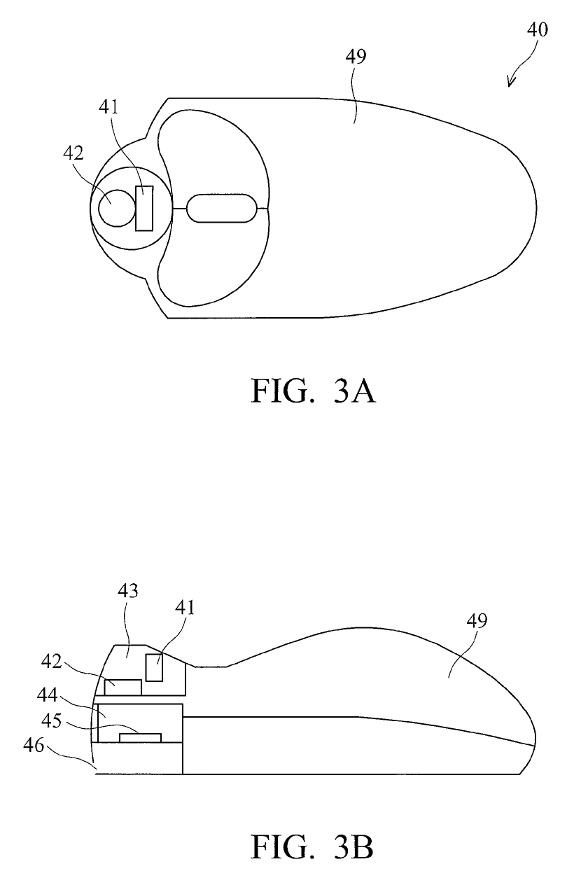

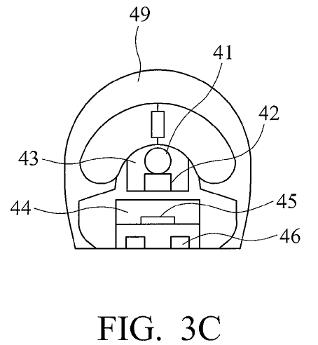

FIGS. 3A, 3B and 3C depict a second embodiment of a computer mouse of the invention, wherein the computer mouse 40 has a body 49, and the body 49 has a microphone chamber 43 and a speaker chamber 44. A microphone module including a main microphone 41 and a reference microphone 42 is firmly disposed in the microphone chamber 43 for receiving sound. The main microphone 41 may be omni-directional or uni-directional. Similarly, the reference microphone 42 may be omni-directional or uni-directional.

The speaker chamber 44 has a loudspeaker 45 firmly disposed therein and an acoustic opening 46 provided thereon. Thus, sound from the loudspeaker 45 is transmitted out of acoustic opening 46. In this embodiment, the microphone module is disposed at the top of the body 49, and the acoustic opening 46 is provided at the front of the body 49.

The acoustic opening may be disposed at the top, the side, or the front of the body as long as the hand of a user does not cover the acoustic opening during normal use. Furthermore, the microphone module may be disposed at the top, the side, or the front of the body, and may include a single microphone.

The computer mouse of the invention may be a universal serial bus (USB) mouse, a Bluetooth mouse, or others, described via a block diagram in the following.

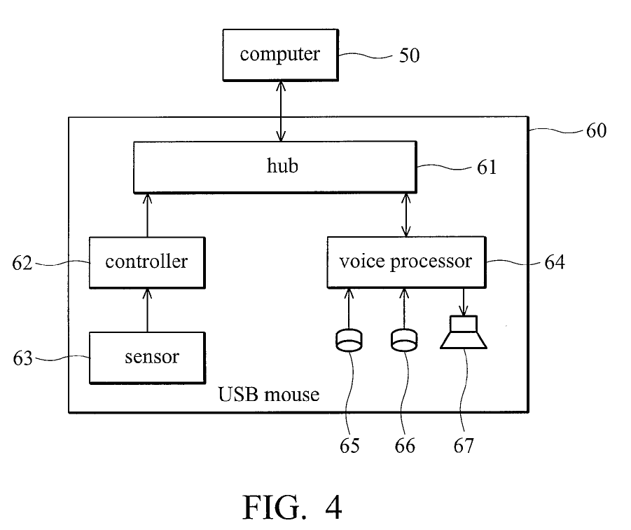

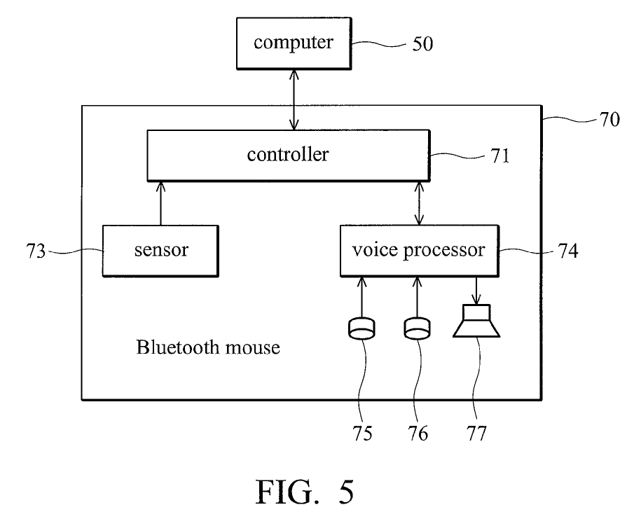

Referring to FIG. 4, a USB mouse 60 in accordance with the invention includes a voice processor 64, a sensor 63, a controller 62, and a hub 61. The microphone module including a main microphone 65 and a reference microphone 66 receives sound and generates an electrical signal. The voice processor 64 receives the electrical signal and performs beam-forming, noise suppression, and echo cancellation to obtain an acoustic signal. Also, the sensor 63 senses movement of the USB mouse 60 and generates a signal. The controller 62 processes the signal to obtain a track signal. The hub 61 arbitrates the track signal and the acoustic signal for output to a computer 50. Furthermore, the computer 50 is capable of sending an acoustic signal through the hub 61 to the voice processor 64. Then, the voice processor 64 processes the acoustic signal for the loudspeaker 67 to make sound.

Referring to FIG. 4, a Bluetooth mouse 70 in accordance with the invention includes a voice processor 74, a sensor 73, and a controller 71. The microphone module including a main microphone 75 and a reference microphone 76 receives sound and generates an electrical signal. The voice processor 74 receives the electrical signal and performs beam-forming, noise suppression, and echo cancellation to obtain an acoustic signal. Also, the sensor 73 detects movement of the Bluetooth mouse 70 and generates a signal. The controller 71 processes the signal and the acoustic signal and sends a Bluetooth signal to a computer 50. The computer 50 is capable of sending a Bluetooth signal with acoustic data to the controller 71. Then, the controller 71 processes the Bluetooth signal for the loudspeaker 77 to make sound.

From the previous descriptions, it is understood that the invention integrates a computer mouse with a microphone module and a loudspeaker, thereby increasing the available space on the desktop and improving the work environment.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A computer mouse, comprising:
a body;
a microphone module fixed to the body; and
a loudspeaker fixed to the body.

2. The computer mouse as claimed in claim 1, wherein the microphone module is disposed at the front of the body.

3. The computer mouse as claimed in claim 1, wherein the microphone module is disposed at a side of the body.

4. The computer mouse as claimed in claim 1, wherein the microphone module is disposed at a top of the body.

5. The computer mouse as claimed in claim 1, wherein the microphone module comprises a main microphone and a reference microphone.

6. The computer mouse as claimed in claim 5, wherein the main microphone is a uni-directional microphone.

7. The computer mouse as claimed in claim 5, wherein the main microphone is an omni-directional microphone.

8. The computer mouse as claimed in claim 5, wherein the reference microphone is a uni-directional microphone.

9. The computer mouse as claimed in claim 5, wherein the reference microphone is an omni-directional microphone.

10. The computer mouse as claimed in claim 1, wherein the body comprises a speaker chamber with the loudspeaker disposed therein and an acoustic opening provided thereon.

11. The computer mouse as claimed in claim 10, wherein the acoustic opening is provided at the front of the body.

12. The computer mouse as claimed in claim 10, wherein the acoustic opening is provided at a side of the body.

13. The computer mouse as claimed in claim 10, wherein the acoustic opening is provided at a top of the body.

14. The computer mouse as claimed in claim 1, wherein the computer mouse is a universal serial bus mouse.

15. The computer mouse as claimed in claim 14, wherein the microphone module receives sound and generates an electrical signal, and the computer mouse further comprises a voice processor processing the electrical signal to obtain an acoustic signal, a sensor detecting movement of the computer mouse and generating a signal, a controller processing the signal to obtain a track signal, and a hub arbitrating the track signal and the acoustic signal for output.

16. The computer mouse as claimed in claim 15, wherein the voice processor performs beam-forming, noise suppression, and echo cancellation on the electrical signal to obtain the acoustic signal.

17. The computer mouse as claimed in claim 1, wherein the computer mouse is a Bluetooth mouse.

18. The computer mouse as claimed in claim 17, wherein the microphone module receives sound and generates an electrical signal, and the computer mouse further comprises a voice processor processing the electrical signal to obtain an acoustic signal, a sensor detecting movement of the computer mouse and generating a signal, a controller processing the signal and the acoustic signal to obtain a Bluetooth signal for output.

19. The computer mouse as claimed in claim 18, wherein the voice processor performs beam-forming, noise suppression, and echo cancellation on the electrical signal to obtain the acoustic signal.
